(19) United States
(12) Patent Application Publication
(10) Pub. No.: US 2026/0194051 A1
(43) Pub. Date: Jul. 9, 2026

(54) RECIPROCATING COMPRESSOR WITH DAMPERS

(71) Applicant: LG ELECTRONICS INC., Seoul (KR)

(72) Inventors: Kiwook SONG, Seoul (KR); Sukang KIM, Seoul (KR); Kihun KIM, Seoul (KR)

(21) Appl. No.: 19/381,208

(22) Filed: Nov. 6, 2025

(30) Foreign Application Priority Data
Jan. 9, 2025 (KR) 10-2025-0003654

(51) Int. Cl. F04B 39/00; F04B 35/04

(52) U.S. Cl. CPC F04B 39/0044; F04B 35/04

(57) ABSTRACT

A reciprocating compressor provided with a damper is disclosed. The compressor includes a cylinder cover coupled to one side of the cylinder block. The compressor further includes a damper. The damper is coupled to a mounting portion that protrudes laterally from both sides of the cylinder cover. The damper may be directly assembled to a detachable cylinder cover such that the damper can be disposed only in a portion where the damper function is required. Through this, the material requirements of the damper may be reduced, and assembly and productivity may be improved.

### CROSS-REFERENCE TO RELATED APPLICATION

Pursuant to 35 U.S.C. § 119(a), this application claims the benefit of the earlier filing date and the right of priority to Korean Patent Application No. 10-2025-0003654, filed on Jan. 9, 2025, the contents of which are incorporated by reference herein in their entirety.

### BACKGROUND

### 1. Field

The present disclosure relates to a reciprocating compressor with dampers that can protect a main body inside a housing from external impact.

### 2. Description of the Related Art

A compressor is a device provided with a motor unit and a compression unit to compress refrigerant that has passed through a refrigeration and air conditioning device such as a refrigerator or air conditioner, and transmit the compressed refrigerant to a condenser.

The compressor may be divided into open and closed types depending on its closed construction.

A closed compressor accommodates a motor unit and a compression unit within a single, completely closed housing (also called a “housing”).

The compressor may be classified into reciprocating, rotary, vane, and scroll types according to a method of compressing the refrigerant.

The compression unit of a reciprocating compressor includes a piston and a connecting rod. The piston reciprocates inside a cylinder block. The connecting rod converts a rotational motion of a crankshaft, which is pressed into a rotor, into a linear motion.

The piston may receive power from the connecting rod to compress the refrigerant stored in the cylinder block to a preset pressure.

Prior art patent document EP 3730789 A1 (published on Oct. 28, 2020; hereinafter, referred to as patent document 1) discloses a refrigerant compressor.

According to patent document 1, a reciprocating refrigerant compressor includes a cylinder block provided inside a housing, a protruding portion protruding from an upper side of the cylinder block, and a damper surrounding the protruding portion.

The damper may serve to prevent and buffer a collision between the protruding portion and the housing due to a vibration of the cylinder block when the compressor is driven.

A cylinder cover coupled to one side of the cylinder block is provided. The protruding portion and a damper surrounding the protruding portion are not provided on a detachable cylinder cover, but are provided on an upper side of the cylinder block that functions as a cylinder housing.

However, the damper of patent document 1 requires a separate assembly structure to be fixed to a body made of a different material (e.g., iron-based material) while using expensive rubber.

In addition, the damper is disposed to cover a part of an upper side of the cylinder block disposed with a complex structure, and a shape of the damper is implemented even in a portion where a damper function is unnecessary, which causes problems such as an increase in material requirements, an increase in cost, and a decrease in assembly efficiency.

Prior art patent document EP 3283767 B1 (published on Sep. 26, 2018; hereinafter, referred to as patent document 2) discloses a refrigerant compressor.

According to patent document 2, the refrigerant compressor includes a damping device to reduce noise. The damping device includes an outer element and an inner element. The outer element is configured to surround the inner element.

The inner element is connected to a drive device. The inner element is configured to support the damping device.

The outer element is formed of a material such as rubber to perform a damping function to alleviate impact when colliding with the inner element.

However, the inner elements are coupled to each other by passing through the cylinder block without passing through a stator.

In the case of a structure in which the inner element passes through only the cylinder block, a diameter of the cylinder block must be larger than that of the stator, or the cylinder block must have a structure that surrounds the stator, so there is a problem in that a diameter (size) of the compressor increases.

In addition, there is a disadvantage in that a number of components increases because a separate inner element is required to support the damping device.

### SUMMARY

An aspect of the present disclosure is to provide a reciprocating compressor provided with a damper having a structure that can solve the foregoing problems.

A first aspect is to provide a reciprocating compressor provided with a damper having a structure in which the damper can be assembled only to a specific portion requiring a damper function without a separate connecting structure.

A second aspect is to provide a reciprocating compressor provided with a damper having a structure that can minimize material requirements and reduce costs.

A third aspect is to provide a reciprocating compressor provided with a damper having a structure that can be easily assembled into a single component of a detachable cylinder cover.

A fourth aspect is to provide a reciprocating compressor provided with a damper having a structure that can prevent the damper from being disengaged or tearing due to external impact during operation.

A fifth aspect is to provide a reciprocating compressor provided with a damper having a simple structure.

As a result of intensive research, the inventors of the present disclosure have found that the first to fourth aspects of the present disclosure may be achieved by the following embodiments of the present disclosure.

In order to achieve the foregoing objectives, a compressor according to the present disclosure may include a housing; a motor unit provided on an inner side of the housing, and provided with a crankshaft, a rotor coupled to the crankshaft, and a stator surrounding the rotor; a compression unit including a cylinder block provided on the inner side of the housing, a piston disposed to be reciprocally movable inside the cylinder block, and a connecting rod connected to the crankshaft and the piston; a cylinder cover coupled to one side of the cylinder block; and a damper mounted on a side surface of the cylinder cover.

Through this, the damper may be mounted on a portion requiring a damper function, for example, the cylinder cover, thereby reducing the material requirements and costs of the damper using expensive rubber material.

According to an example, the damper may be provided in plurality, and the plurality of dampers may further include a first damper coupled to one side surface of the cylinder cover; and a second damper coupled to the other side surface of the cylinder cover toward a direction opposite to the first damper.

Through this, the damper may minimize impact transmitted from both sides of the cylinder cover to the housing.

According to an example, the damper may be mounted on a mounting portion protruding from a side surface of the cylinder cover. The damper may include a receiving portion that surrounds and receives the mounting portion.

Through this, the damper may be supported by being coupled to the mounting portion of the cylinder cover through the receiving portion.

According to an example, the mounting portion may include an extension portion extending in one direction from a side surface of the cylinder cover; and a protruding portion disposed to protrude in a different direction crossing the one direction from the extension portion.

Through this, the extension portion and the protruding portion may stably support the damper with a simple structure.

According to an example, the receiving portion may include a first receiving portion configured to receive the protruding portion, and disposed in a straight shape; and a second receiving portion that receives the extension portion, and extends in the one direction from the first receiving portion.

Through this, the first receiving portion and the second receiving portion may stably support the protruding portion and extension portion of the damper with a simple structure.

According to an example, the damper may be provided with a curved portion on an outer corner portion of the receiving portion that receives the protruding portion. The curved portion may be spaced apart from an inner side surface of the housing by a preset distance, and disposed to correspond to a curved shape of the inner side surface of the housing.

Through this, the curved portion is disposed to have a curvature that is the same as or similar to an inner side surface of the housing, thereby protecting a compressor body from external impact.

According to an example, the damper may include a damper upper surface portion constituting an upper surface of the damper so as to cover upper portions of the protruding portion and the extension portion; a damper front surface portion disposed toward a direction opposite to the piston to constitute a front surface of the damper; a damper rear surface portion disposed toward the piston to constitute a rear surface of the damper; and a damper side surface portion connecting the damper front surface portion and the damper rear surface portion.

The curved portion may include a first curved portion disposed at an corner where the damper upper surface portion and the damper side surface portion are connected; and a second curved portion disposed at an corner where the damper front surface portion and the damper side surface portion are connected.

Through this, the first curved portion may be disposed to have a curvature that is the same as or similar to a curved surface of an corner where the upper and side surface portions of the inner side surface of the upper housing meet, thereby protecting the compressor body from external impact.

In addition, the second curved portion may be disposed to have a curvature that is the same as or similar to a curved surface of an corner where the front and side surface portions of the inner side surface of the upper housing meet, thereby protecting the compressor body from external impact.

According to an example, the protruding portion may be provided in plurality, wherein the plurality of protruding portions include a first protruding portion protruding from one side of the extension portion in another direction crossing the one direction; and a second protruding portion protruding in still another direction crossing the one direction from one side of the extension portion toward a direction opposite to the first protruding portion.

Through this, the first protruding portion and the second protruding portion may prevent the damper from being disengaged from the mounting portion of the cylinder cover.

According to an example, the receiving portion may include a plurality of catching protrusions disposed to protrude toward one side of the extension portion, and coupled to engage with the protruding portions.

The plurality of catching protrusions may include a first catching protrusion disposed to overlap the first protruding portion in the one direction; and a second catching protrusion disposed to overlap the second protruding portion in the one direction.

Through this, the plurality of catching protrusions may be coupled to engage with the protruding portions so as to strengthen a bonding force between the damper and the mounting portion.

According to an example, the damper may include a damper rear surface portion disposed toward the piston to surround rear surfaces of the protruding portion and the extension portion; and a damper front surface portion disposed toward a direction opposite to the piston to surround front surfaces of the protruding portion and the extension portion.

Through this, the damper front surface portion and the damper rear surface portion may be disposed in a front-rear direction with the protruding portion interposed therebetween, thereby limiting the damper from moving in a front-rear direction with respect to the protruding portion.

According to an example, the extension portion and the protruding portion may be perpendicular to each other.

Through this, the extension portion and the protruding portion may be disposed to cross each other, thereby maintaining structural stability.

According to an example, the damper may be arranged to be spaced apart from an inner side surface of the housing by a preset distance in at least one of up-down, front-rear, and left-right directions.

Through this, an outer inner surface of the damper and an inner side surface of the housing may be spaced apart from each other by a preset distance, thereby alleviating impact when colliding with the housing.

According to an example, the damper may be a front damper disposed on a front side of the cylinder block in a direction close to the piston that moves such that refrigerant sucked into a compression chamber of the cylinder block is compressed.

Through this, the front damper may alleviate external impact when colliding with the housing on a front side of the cylinder block.

According to an example, the cylinder cover may be disposed in a square shape, and corners of the cylinder cover may be fastened to the cylinder block by a plurality of fastening members.

The damper may be mounted so as to cover an upper corner of the cylinder cover.

Through this, the damper may alleviate impact when an upper side of the cylinder cover and an inner side surface of the housing collide.

According to an embodiment of the present disclosure, the following effects may be achieved.

First, a plurality of dampers may be mounted on upper portions of both side surfaces of a cylinder cover. A mounting portion may be provided on an upper portion of a side surface of the cylinder cover. The mounting portion may be disposed to protrude laterally from an upper portion of a side surface of the cylinder cover.

The mounting portion is disposed integrally with the cylinder cover. Through this, the damper may be mounted on the mounting portion and assembled directly to the cylinder cover without a separate connecting structure, thereby reducing a number of components.

Second, the damper may be provided only in a portion requiring a damping function through the mounting portion, thereby reducing material costs and production costs.

Third, the cylinder cover may be fastened to a cylinder block by a fastening member such as a screw. The cylinder cover can be separated from the cylinder block. The cylinder cover may be manufactured separately from the cylinder block as a single component. The cylinder cover constitutes a discharge chamber, and has a simple rectangular structure.

The mounting portion may include an extension portion and a protruding portion. The extension portion is disposed to protrude laterally from a side surface of the cylinder cover. The protruding portion may include a first protruding portion and a second protruding portion.

The first protruding portion may be disposed to protrude upward from an upper surface of the extension portion. The second protruding portion may be disposed to protrude downward from a lower surface of the extension portion.

The damper includes a receiving portion. The receiving portion is configured to receive and surround the mounting portion. The receiving portion may be press-fitted into and coupled to the mounting portion.

Through this, the damper may be easily assembled to a side surface of the cylinder cover through the mounting portion.

Fourth, the receiving portion may be configured with a first receiving portion and a second receiving portion.

The first receiving portion is configured to receive and surround the protruding portion and one side surface of the extension portion. The second receiving portion is configured to receive and surround a part of the extension portion, for example, upper and lower surfaces thereof.

The damper further includes a catching protrusion. The catching protrusion may be configured with a first catching protrusion and a second catching protrusion. The first catching protrusion may be disposed to protrude from an inner side surface of the receiving portion toward an upper surface of the extension portion.

The second catching protrusion may be disposed to protrude from an inner side surface of the receiving portion toward a lower surface of the extension portion. The first catching protrusion may be coupled to engage with the first protruding portion. The second catching protrusion may be coupled to engage with the second protruding portion.

Through this, the catching protrusion may limit the damper from moving in a left-right direction on the mounting portion.

The damper may further include a damper front surface portion and a damper rear surface portion. The damper front surface portion constitutes a front surface of the damper. The damper front surface portion surrounds front surfaces of the protruding portion and the extension portion. The damper rear surface portion constitute a rear surface of the damper. The damper rear surface portion surrounds a rear surface of the damper.

Through this, the damper front and rear surface portions may limit the damper from moving in a front-rear direction on the mounting portion.

The damper may further include a damper upper surface portion and a damper lower surface portion. The damper upper surface portion constitutes an upper surface of the damper. The damper lower surface portion constitutes a lower surface of the damper. The damper upper and lower surface portions may surround upper and lower surfaces of the mounting portion, respectively, to prevent the damper from being separated from the mounting portion in an up-down direction.

Fifth, the receiving portion of the damper includes a straight portion. The straight portion is disposed to face a side surface of the protruding portion. The straight portion may be disposed as a flat surface. The side surfaces of the straight portion and the protruding portion may be in surface contact with each other.

Through this, the straight portion and the protruding portion of the damper may be in surface contact with each other, thereby allowing the receiving portion of the damper and the protruding portion of the mounting portion to be brought into close contact with each other. A bonding force between the damper and the mounting portion may be maximized.

The damper may have a simple structure, and may be compactly disposed above the cylinder block.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view showing a compressor according to one embodiment of the present disclosure;

FIG. 2 is a cross-sectional view taken along line II-II in FIG. 1;

FIG. 3 is a conceptual view showing a state in which a damper mounted on a side surface of a cylinder cover in FIG. 1 is viewed from the front side;

FIG. 4 is a conceptual view showing a state in which the damper mounted on the side surface of the cylinder cover in FIG. 3 is viewed from the rear side;

FIG. 5 is an exploded view of the damper and the cylinder cover in FIG. 3;

FIG. 6 a to c are conceptual views showing a state in which the cylinder cover of FIG. 5 is viewed from the front, upper, and right sides, respectively;

FIG. 7, which is a cross-sectional view taken along line VII-VII in FIG. 3, is a conceptual view showing a state in which the damper mounted on both side surfaces of the cylinder cover is viewed from above; and

FIG. 8, which is a cross-sectional view taken along line VIII-VIII in FIG. 3, is a conceptual view showing a state in which the damper mounted on both sides of the cylinder cover is viewed from the front side.

### DETAILED DESCRIPTION OF THE EMBODIMENTS

Hereinafter, a reciprocating compressor provided with a damper according to an embodiment of the present disclosure will be described in detail with reference to the accompanying drawings.

In the following description, descriptions of some elements may be omitted to clarify the features of the present disclosure.

### 1. Definition of Terms

The terms including an ordinal number such as first, second, and the like may be used to describe various elements, but the elements should not be limited by those terms. The terms are used merely for the purpose to distinguish one element from another element.

It should be understood that when an element is referred to as being “connected to” or “coupled to” another element, the element may be directly connected to or coupled to the other element or intervening elements may also be present. On the contrary, it should be understood that when an element is referred to being “directly connected” or “directly coupled” to another element, there are no intervening elements present.

A singular expression used herein may include a plural expression unless clearly defined otherwise in the context.

The term “radial” as used in the following description refers to a shape that extends out in all directions from a central point like spokes of a wheel.

The term “axial direction” as used in the following description refers to a longitudinal direction of a crankshaft.

The term “axial direction” as used in the following description may refer to an up-down direction.

The term “radial direction” as used in the following description, refers to a longitudinal direction of a line segment from the center of a circle or cylinder to a point on a circumference.

The term “circumferential direction” as used in the following description refers to a direction of circumference of a circle.

The term “crankshaft” as used in the following explanation, which is a shaft that converts rotational motion into linear motion, refers to a shaft mainly used to move a piston.

The term “journal” as used in the following description refers to a shaft part supported by bearings or the like.

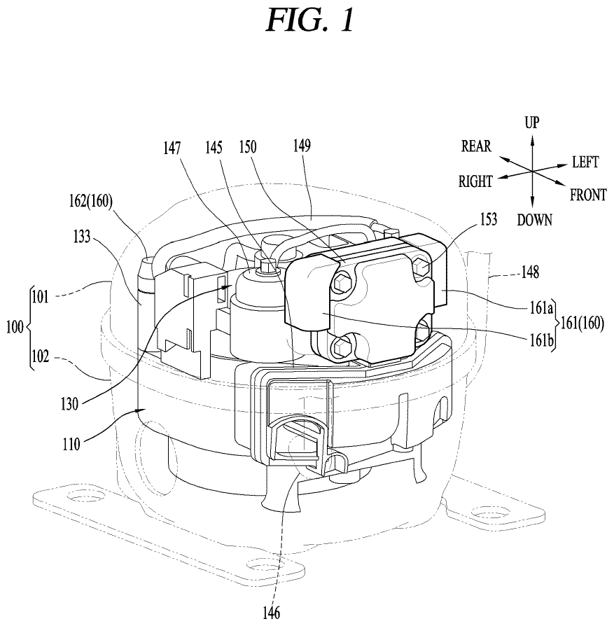

The terms “front side,” “rear side,” “left side,” “right side,” “upper side,” and “lower side” used in the following description will be understood with reference to the coordinate system shown in FIG. 1.

### 2. Description of Configuration of Compressor According to One Embodiment of Present Disclosure

In this embodiment, a compressor may be applied to a closed compressor.

In this embodiment, a compressor may be applied to a reciprocating compressor. However, the present disclosure is not limited thereto.

FIG. 1 is a perspective view showing a compressor according to one embodiment of the present disclosure.

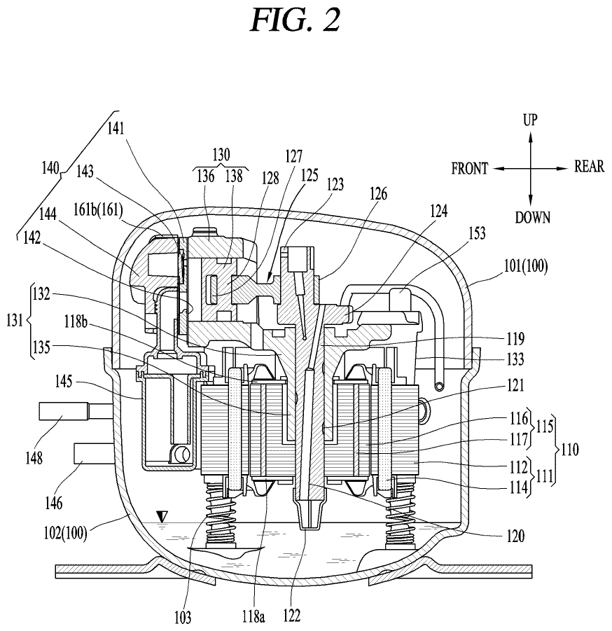

FIG. 2 is a cross-sectional view taken along line II-II in FIG. 1.

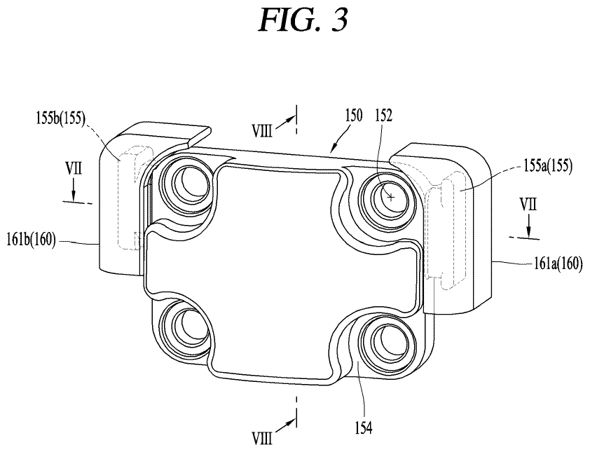

FIG. 3 is a conceptual view showing a state in which a damper mounted on a side surface of a cylinder cover in FIG. 1 is viewed from the front side.

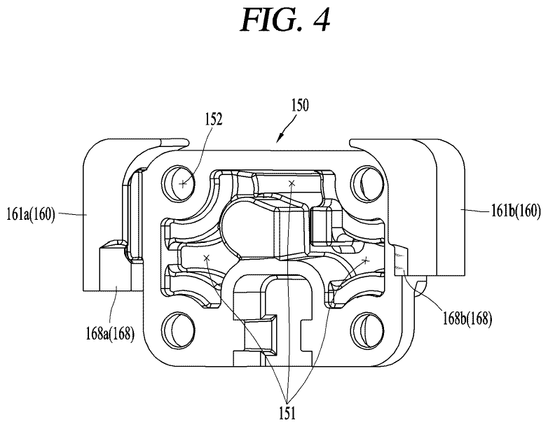

FIG. 4 is a conceptual view showing a state in which the damper mounted on the side surface of the cylinder cover in FIG. 3 is viewed from the rear side.

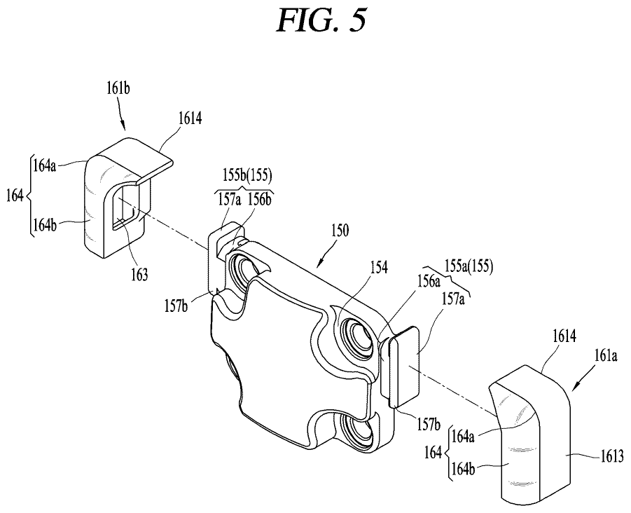

FIG. 5 is an exploded view of the damper and the cylinder cover in FIG. 3.

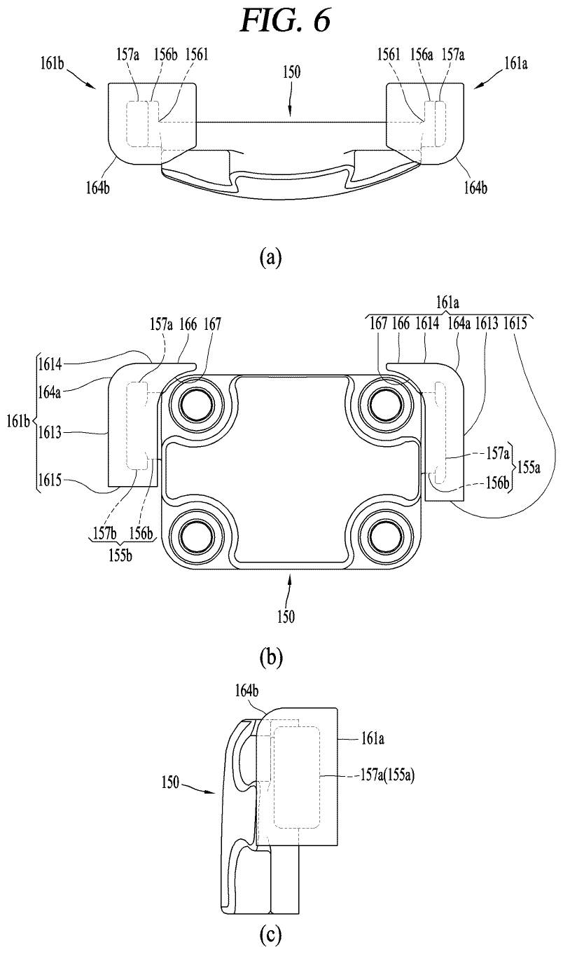

FIG. 6 a to c are conceptual views showing a state in which the cylinder cover of FIG. 5 is viewed from the front, upper, and right sides, respectively.

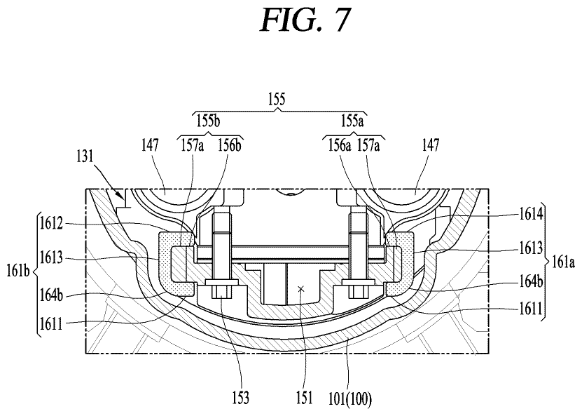

FIG. 7, which is a cross-sectional view taken along line VII-VII in FIG. 3, is a conceptual view showing a state in which the damper mounted on both side surfaces of the cylinder cover is viewed from above.

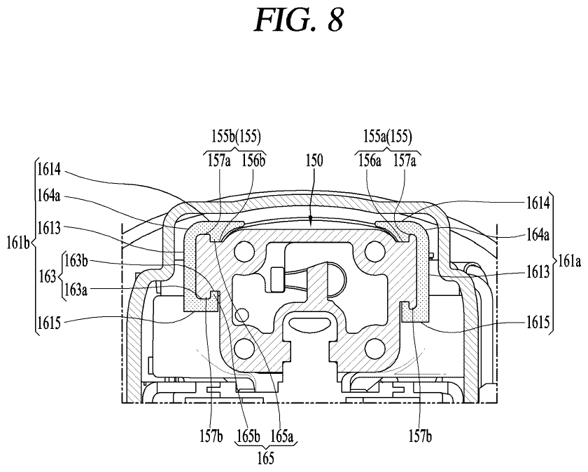

FIG. 8, which is a cross-sectional view taken along line VIII-VIII in FIG. 3, is a conceptual view showing a state in which the damper mounted on both sides of the cylinder cover is viewed from the front side.

A compressor according to this embodiment may be configured to include a housing 100, a compression unit 130, and a motor unit. The motor unit may be implemented as a drive motor 110.

The housing 100 constitutes an exterior of the compressor. A receiving space is provided inside the housing 100. The receiving space of the housing 100 may be configured to be sealed.

The compression unit 130 and the drive motor 110 may be received into the housing 100.

The housing 100 may include a lower housing 102 and an upper housing 101.

The lower housing 102 may be configured in a semi-cylindrical or hemispherical shape. The lower housing 102 is disposed below the upper housing 101. The lower housing 102 may be disposed to be opened upward. The lower housing 102 may be named a first housing.

The upper housing 101 is coupled to cover an upper portion of the lower housing 102. The upper housing 101 may be named a second housing.

Through this, the upper housing 101 and the lower housing 102 may seal the receiving space of the housing 100.

The drive motor 110 may include a stator 111 and a rotor 115.

The stator 111 may be received into the receiving space of the housing 100. The stator 111 may be elastically supported on a bottom surface of the lower housing 102.

For example, the stator 111 may be elastically supported by a spring 103. An elastic support element for elastically supporting a lower portion of the stator 111 may include a spring 103, a first support portion 104, and a second support portion 105.

The spring 103 may be configured with a coil spring. The first support portion 104 may be provided fixedly on a bottom surface of the lower housing 102. The first support portion 104 may be disposed in a cylindrical shape. A first flange portion protruding radially to support a lower end portion of the spring 103 may be provided on an outer peripheral portion of the first support portion 104.

The second support portion 105 may be provided fixedly on a lower surface of the stator 111. The second support portion 105 may be configured to surround a head portion of the fastening member to be described later. A receiving groove that receives the head portion of the fastening member may be further provided inside the second support portion 105.

A second flange portion protruding radially to support an upper end portion of the spring 103 may be provided on an outer peripheral portion of the second support portion 105.

Through this, the spring 103 may elastically support the stator 111. The spring 103 may prevent a vibration generated during the operation of the compressor from being directly transmitted to the housing 100.

The rotor 115 may be rotatably provided on an inner side of the stator 111.

The stator 111 may include a stator core 112 and a stator coil 114.

The stator core 112 may be formed by stacking and coupling a plurality of electrical steel sheets. The stator core 112 may be disposed in a square shape.

The stator core 112 may be configured with a back yoke, a plurality of teeth, and a plurality of slots. The back yoke may be disposed in a circular ring shape.

The teeth may be configured to protrude radially from an inner side surface of the back yoke. The slots may be disposed to pass through the stator 111 along an axial direction.

The plurality of teeth may be alternately disposed with a plurality of slots in a circumferential direction. A pole shoe may be provided at an inner end portion of the teeth. The pole shoe may be disposed to protrude on both sides along a circumferential direction from the inner end portion of the teeth. A radial thickness of the pole shoe may be disposed between outer and inner side surfaces of the pole shoe in a radial direction.

The stator coil 114 may be wound on the stator core 112 through the slots.

The stator core 112 may be fixed to a lower surface of the cylinder block 131 by the fastening member. The fastening member may be implemented as a bolt or screw.

The fastening member may pass through the stator core 112 and the cylinder block 131 to be described later so as to be coupled thereto.

A first through hole may be disposed at an inside of the stator core 112 to pass therethrough. A second through hole may be disposed at an inside of the cylinder block 131 to pass therethrough. The fastening member may pass through the first through hole and the second through hole.

A plurality of fastening members may be provided to fasten the stator core 112 and the cylinder block 131. For example, the plurality of fastening members may be fastened in a total of four, two each at front and rear sides of the stator core 112 and the cylinder block 131. A plurality of fastening members may be arranged to be spaced apart in front-rear and left-right directions.

A rotor receiving hole may be disposed at an inside of the stator core 112 along an axial direction. The rotor receiving hole may be disposed in a cylindrical shape. The stator 111 may be configured to surround the rotor 115. The rotor 115 may be received into a rotor receiving hole of the stator core 112.

The rotor 115 may include a rotor core 116 and a plurality of permanent magnets or a plurality of rotor bars 117. In this embodiment, it shows a state in which the plurality of rotor bars 117 are mounted on an inner side of the rotor core 116.

The rotor core 116 may be formed by stacking and coupling a plurality of electrical steel sheets. The rotor core 116 may be disposed in a cylindrical shape.

A first shaft hole may be disposed at the center of the rotor core 116 to pass axially therethrough. The first shaft hole may be located below the rotor core 116. A lower portion of the rotor core 116 may be press-fitted into and coupled to at least a part of the crankshaft 119 through the first shaft hole.

The crankshaft 119 may be coupled to the rotor core 116 through the first shaft hole.

A rotor bar receiving hole may be disposed on an inner side of the rotor core 116 to pass therethrough along an axial direction. The rotor bar 117 may extend in an axial direction. The rotor bar 117 may be formed of a conductor such as aluminum or an aluminum alloy.

The rotor bar 117 may be axially inserted and coupled into the rotor core 116 through the rotor bar receiving hole. The plurality of rotor bars 117 may be disposed to be spaced apart along a circumferential direction of the rotor core 116.

End rings 118a, 118b may extend in a circumferential direction. The end rings 118a, 118b may prevent the rotor bar 117 from being axially separated from the rotor bar receiving hole. A first end ring 118a may be coupled to a lower side of the rotor core 116. A second end ring 118b may be coupled to an upper side of the rotor core 116.

Through this, when external power is applied to the stator coil 114, a magnetic field may be formed around the stator coil 114. The rotor 115 may rotate by an electromagnetic interaction with the stator 111. The drive motor 110 may generate power for a reciprocating motion of the compression unit 130.

An eccentric shaft 123 is provided at an upper end portion of the crankshaft 119. The eccentric shaft 123 may be disposed eccentrically to one side in a radial direction from an upper portion of the crankshaft 119. A counterweight 124 may be disposed to protrude radially outward from the upper portion of the crankshaft 119. The eccentric shaft 123 may protrude upward from one side of the counterweight 124.

The counterweight 124 may be disposed at an upper end portion of the crankshaft 119 toward an opposite direction to the eccentric shaft 123 with respect to the crankshaft 119. The counterweight 124 may be a weight. Through this, the counterweight 124 may balance the center of rotation with respect to the eccentric shaft 123 based on the crankshaft 119.

A connecting rod 125 may be disposed between the drive motor 110 and the compression unit 130. The connecting rod 125 is configured to convert a rotational motion of the drive motor 110 into a reciprocating motion of the compression unit 130.

An eccentric shaft coupling portion 126 may be disposed in a ring shape at one end portion of the connecting rod 125. The eccentric shaft coupling portion 126 may be surrounded around the eccentric shaft 123. The eccentric shaft 123 may be received into the eccentric shaft coupling portion 126 to allow the eccentric shaft 123 and the eccentric shaft coupling portion 126 to be coupled to each other.

A piston coupling portion 127 may be disposed in a ring shape at the other end portion of the connecting rod 125. The piston coupling portion 127 is configured to surround a connecting pin 128 to be described later. The connecting pin 128 may be coupled to an inner side of a piston 138. The connecting pin 128 may be connected to the piston coupling portion 127 to pass through the piston coupling portion 127 in an up-down direction. The connecting rod 125 may be coupled to the piston 138.

Through this, the eccentric shaft 123 may rotate together with the crankshaft 119 around the crankshaft 119. The connecting rod 125 may convert a rotational motion of the eccentric shaft 123 into a reciprocating motion of the piston 138.

The compression unit 130 may be configured to include the cylinder block 131 and the piston 138.

The cylinder bock 131 may be disposed on an upper side of the drive motor 110. The cylinder block 131 is coupled to an upper portion of the stator 111 of the drive motor 110 to be elastically supported by the housing 100.

The cylinder block 131 may be configured to include a frame 132, a stator coupling portion 133, a shaft support portion 135, and a cylinder 136.

The frame 132 may be disposed to extend in a horizontal direction crossing an axial direction. The frame 132 may be disposed in a flat shape.

The stator coupling portion 133 may be disposed to protrude downward from an edge of the frame 132 toward the stator 111. The stator coupling portion 133 may be fastened to the stator 111 by the fastening member. The cylinder block 131 may be fastened to the stator 111 by the fastening member passing through the stator coupling portion 133.

Through this, the cylinder block 131 may be elastically supported by the lower housing 102 together with the stator 111.

The shaft support portion 135 may extend axially from a central portion of the frame 132. A shaft receiving hole may be disposed on an inner side of the shaft support portion 135 to pass axially therethrough.

The crankshaft 119 may be coupled to the shaft support portion 135 through the shaft receiving hole so as to be rotatably mounted inside the frame 132.

A journal bearing may be disposed or omitted between an inner peripheral surface of the shaft support portion 135 and an outer peripheral surface of the crankshaft 119. The journal bearing may be disposed in a cylindrical shape. An inner peripheral surface of the journal bearing is configured to surround an outer peripheral surface of the crankshaft 119.

The inner peripheral surface of the journal bearing may be in surface contact with the outer peripheral surface of the crankshaft 119. The inner peripheral surface of the shaft support portion 135 is configured to surround the outer peripheral surface of the journal bearing. The inner peripheral surface of the journal bearing and the inner peripheral surface of the shaft support portion 135 may be in surface contact with each other.

Through this, the journal bearing may support the crankshaft 119 so as to allow the crankshaft 119 to rotate with respect to the shaft support portion 135. The journal bearing may limit the crankshaft 119 from being moved in a radial direction.

The journal bearing may be relatively inexpensive compared to a conventional ball bearing, thereby greatly contributing to cost improvement. In this embodiment, the journal bearing may be omitted. However, an oil layer may be formed between the inner peripheral surface of the shaft support portion 135 and the outer peripheral surface of the crankshaft 119. Through this, the shaft support portion 135 may perform the role of a journal bearing.

An oil passage 120 is disposed inside the crankshaft 119. An oil passage groove 121 may be disposed in a spiral direction on the outer peripheral surface of the crankshaft 119. The oil passage groove 121 may be connected in communication with the oil passage 120.

An oil pump 122 may be provided at a lower end portion of the crankshaft 119. An upper end portion of the oil pump 122 may be connected in communication with the oil passage 120 of the crankshaft 119. A lower end portion of the oil pump 122 may be disposed to sink in the oil stored in the lower housing 102.

Through this, the oil pump 122 may pump oil, and supply it to the inner peripheral surface of the shaft support portion 135 through the oil passage 120 and oil passage groove 121 of the crankshaft 119.

The shaft support portion 135 may be received into a second shaft hole of the rotor core 116. The second shaft hole may be disposed to have a large diameter at an upper end of the first shaft hole of the rotor core 116.

The second shaft hole may receive at least a part of the shaft support portion 135. The second shaft hole may be disposed to have a step radially outward from the first shaft hole. The second shaft hole may be located above the rotor core 116. A gap may be formed between an inner peripheral surface of the second shaft and an outer peripheral surface of the shaft support portion 135.

Through this, the rotor core 116 may rotate with respect to the shaft support portion 135.

The cylinder 136 is provided on one edge of the frame 132. The cylinder 136 may be disposed eccentrically, radially outward from the center of the frame 132.

A cylindrical hollow portion is disposed on an inner side of the cylinder 136. The cylinder 136 may extend radially with respect to the crankshaft 119. The hollow portion may be disposed to pass through the housing 100 in a front-rear direction. The hollow portion may pass radially through a central portion of the frame 132.

The piston 138 may be received into the cylinder 136. A rear side of the piston 138 may be disposed to have an open structure, and a front side of the piston 138 may be disposed to have a closed structure. Here, the front side of the piston 138 is disposed to face an opposite direction of the connecting rod 125 to be described later, and the rear side of the piston 138 is disposed to face the connecting rod 125.

A connecting pin 128 may be provided on the rear side of the piston 138. The connecting pin 128 may be coupled to the piston coupling portion 127 of the connecting rod 125. Through this, the piston 138 may receive a driving force from the drive motor 110 through the connecting rod 125.

A valve assembly 140 may be coupled to a front side of the cylinder 136. The front side of the cylinder 136 is disposed to face an opposite direction to the connecting rod 125. The front side of the piston 138 may form a compression chamber 137 inside the cylinder 136 together with the valve assembly 140.

A suction/discharge unit may be configured to include a valve assembly 140, a suction muffler 145, and a discharge muffler 147. The valve assembly 140 and the suction muffler 145 may be sequentially coupled from an outer opening end of the cylinder 136.

The valve assembly 140 may include a valve plate 141, a suction valve 142, a discharge valve 143, and a cylinder cover 144.

The valve plate 141 is provided to cover a front opening surface of the compression chamber 137. The valve plate 141 may be fastened to the cylinder block 131.

The valve plate 141 may be provided with a suction port and a plurality of discharge ports. The suction port may be disposed to pass through a central portion of the valve plate 141. The discharge ports may be discharged to pass through the periphery of the suction port. The plurality of discharge ports may be disposed to be spaced apart from one another by a preset distance along a peripheral circumference of the suction port.

The suction valve 142 may be rotatably mounted on a rear side of the valve plate 141 toward the piston 138. The suction valve 142 is configured to open and close the suction port. The suction valve 142 may be elastically deformed according to a pressure difference between the compression chamber 137 and a discharge chamber to be described later.

The discharge valve 143 may be rotatably mounted on a front side of the valve plate 141 to face an opposite direction to the piston 138. The discharge valve 143 is configured to open and close the discharge port. The discharge valve 143 may be elastically deformed according to a pressure difference between the compression chamber 137 and a discharge chamber to be described later.

The suction valve 142 and the discharge valve 143 may be selectively opened and closed in opposite directions. During a suction stroke of the piston 138, the suction valve 142 may be opened and the discharge valve 143 may be closed. Alternatively, during a discharge stroke of the piston 138, the suction valve 142 may be closed and the discharge valve 143 may be opened.

The cylinder cover 144 may be fastened to an outer opening end portion of the cylinder block 131 to cover the compression chamber 137. A discharge chamber may be disposed to be recessed into the cylinder cover 144.

The suction muffler 145 may be disposed to have a suction space thereinside. An inlet of the suction muffler 145 may be connected in communication with the suction pipe 146, and an outlet of the suction muffler 145 may be connected in communication with a suction side of the valve assembly 140.

The suction muffler 145 may be fixed to the valve assembly 140. The suction muffler 145 may be connected in communication with a suction port of the valve plate 141. The suction muffler 145 may transmit refrigerant sucked through the suction pipe 146 to the compression chamber 137 of the cylinder 136.

The discharge muffler 147 may be provided to be separated from the cylinder block 131. The discharge muffler 147 may have a discharge space disposed thereinside. An inlet of the discharge muffler 147 may be connected in communication with a discharge side of the valve assembly 140. A plurality of discharge mufflers may be provided above the cylinder block. The exhaust mufflers may be arranged to be spaced apart from a front side of the cylinder block in a left-right direction.

An operation process of the compressor will be described as follows.

When power is applied to the stator coil 114, a magnetic field is generated around the coil. The stator 111 and the rotor 115 interact electromagnetically to allow the rotor 115 to rotate with respect to the stator 111.

The crankshaft 119 rotates together with the rotor 115. One side of the connecting rod 125 is coupled to the eccentric shaft 123 of the crankshaft 119 to rotate along an orbiting motion of the eccentric shaft 123. The other side of the connecting rod 125 is coupled to the piston 138 so as to move forward and backward in a radial direction of the crankshaft 119.

The piston 138 may reciprocate in a front-rear direction inside the cylinder 136. When the piston 138 moves backward in the cylinder 136, a volume of the compression chamber 137 expands and a pressure in the compression chamber 137 decreases. The refrigerant filled in the suction muffler 145 passes through the suction valve 142 of the valve assembly 140 to be sucked into the compression chamber 137.

Conversely, when the piston 138 moves forward in the cylinder 136, the volume of the compression chamber 137 is compressed and the pressure increases. The refrigerant filled in the compression chamber 137 is compressed, and the discharge valve 143 of the valve assembly 140 is opened to allow the refrigerant to be discharged into the discharge chamber of the cylinder cover 144.

The discharged refrigerant moves to the discharge space of the discharge muffler 147 through a loop pipe 149 and then passes through the loop pipe 149 and discharge pipe 148 to be discharged to a refrigeration cycle, repeating a series of processes.

However, as the piston 138 reciprocates by receiving power from the drive motor 110 transmitted through the connecting rod 125 in the compression chamber 137 of the cylinder 136, vibration occurs in the compression unit 130 and the motor unit. The vibration may cause a collision between components.

For example, the fastening member that fastens the cylinder block 131 of the compression unit 130 and the stator 111 of the motor unit may be elastically supported by the spring 103 to suppress the vibration from being transmitted to the housing 100, but a collision between the cylinder block 131 and the stator 111 and the housing 100 cannot be avoided.

The present disclosure provides a structure of the damper 160 that can minimize vibrations of the cylinder block 131 and the stator 111 from being transmitted to the housing 100.

For example, the two dampers 160 may be provided on front and rear sides of the cylinder block 131, respectively. A damper 161 disposed on a front side of the cylinder block 131 may be named a front damper 161. A damper 162 disposed on a rear side of the cylinder block 131 may be named a rear damper 162.

A front side of the cylinder block 131 may refer to a front side of the cylinder block 131 based on a movement direction of the piston that moves to compress refrigerant sucked into the compression chamber from an upper side of the cylinder block 131. A rear side of the cylinder block 131 refers to a movement direction of the piston that moves to expand refrigerant sucked into the compression chamber from the upper side of the cylinder block 131.

A plurality of rear dampers 162 may be press-fitted into and coupled to a fastening member passing through the stator and the cylinder block 131. A plurality of fastening members may be arranged on edges of the stator 111 and the cylinder block 131.

A plurality of front dampers 161 may be coupled to both side surfaces of the cylinder cover 150. In the following description, the term damper 161 refers to the front damper 161.

The cylinder cover 150 may include front, rear, left side, right side, upper, and lower surfaces.

A front surface of the cylinder cover 150 may be disposed to face a front side surface of an inner side surface of the housing 100 while being spaced apart by a preset distance. Here, the front side surface of the inner side surface of the housing 100 may refer to a side surface in a direction that is closer to the piston that moves to compress refrigerant in the compression chamber.

The front surface of the cylinder cover 150 may be disposed to be convex in a shape corresponding to the front side surface of the housing 100. The front surface of the cylinder cover 150 may include a curved surface formed with a gentle curvature.

A rear surface of the cylinder cover 150 may be disposed toward the valve plate 141 of the valve assembly 140. The rear surface may constitute a flat surface. A discharge chamber 151 may be disposed to be recessed into an inner side of the rear surface of the cylinder cover 150.

Left side, right side, upper, and lower surfaces are disposed between the front and rear surfaces of the cylinder cover 150. A left side surface of the cylinder cover 150 is a side surface toward a left direction of the cylinder cover 150.

A right side surface of the cylinder cover 150 is a side surface toward a right direction of the cylinder cover 150. An upper surface of the cylinder cover 150 is a surface toward an upward direction of the cylinder cover 150. A lower surface of the cylinder cover 150 is a surface toward a downward direction of the cylinder cover 150.

The cylinder cover 150 may be disposed in a square shape. Fastening holes 152 may be disposed at four corners of the cylinder cover 150 to pass therethrough in a front-rear direction. A fastening member 153 such as a screw may be fastened to the cylinder 136 of the cylinder block 131 through the fastening hole 152.

A recessed portion 154 is disposed at the four corners of the cylinder cover 150 to be recessed from front to rear surfaces of the cylinder 136 so as to surround the fastening hole 152.

The cylinder cover 150 may further include a mounting portion 155. The mounting portion 155 may be disposed to protrude from one side surface of the cylinder cover 150. The damper 161 may be mounted on the mounting portion 155. The mounting portion 155 may include a first mounting portion 155a and a second mounting portion 155b.

The first mounting portion 155a may be disposed to protrude from one side surface of the cylinder cover 150, for example, a left side surface thereof. A first damper 161a may be mounted on the first mounting portion 155a. The second mounting portion 155b may be disposed to protrude from another side surface of the cylinder cover 150, for example, a right side surface thereof. A second damper 161b may be mounted on the second mounting portion 155b.

The mounting portion 155 may be configured to include an extension portion 156 and a protruding portion 157. The extension portion 156 may be disposed to protrude in one direction from a side surface of the cylinder cover 150. Here, one direction may refer to, for example, a left or right direction. A neck portion 1561 may be disposed at a point where the extension portion 156 begins to protrude.

The extension portion 156 may be disposed on an upper portion of a side surface of the cylinder cover 150 based on the center of the cylinder cover 150 in an up-down direction.

The extension portion 156 may be disposed in a rectangular shape. Each corner of the extension portion 156 may be disposed to be rounded. A size (area) of the extension portion 156 is larger than that of the neck portion 1561. Here, the area may refer to a size of a surface perpendicular to a protrusion direction of the extension portion 156.

The extension portion 156 may be disposed to protrude rearward from a rear surface of the neck portion 1561. The extension portion 156 may be disposed to protrude rearward from a rear surface of the cylinder cover 150.

A front-rear width is disposed between front and rear surface of the extension portion 156. The front-rear width (thickness) of the neck portion 1561 is disposed between front and rear surfaces of the neck portion 1561. The front-rear width of the extension portion 156 may be greater than that of the neck portion 1561.

A vertical length is disposed between upper and lower surfaces of the extension portion 156. A vertical length of the neck portion 1561 is disposed between upper and lower surfaces of the neck portion 1561. The vertical length of the extension portion 156 may be disposed to be the same as that of the neck portion 1561.

The neck portion 1561 may connect a side surface of the cylinder cover 150 and the extension portion 156. Through this, the neck portion 1561 may increase a support force of the cylinder cover 150 for the extension portion 156.

A vertical length of the extension portion 156 may be greater than the front-rear width of the extension portion 156.

The protruding portion 157 may be disposed to protrude from one side of the extension portion 156. The protruding portion 157 may be provided in plurality. The protruding portion 157 may be disposed in a rectangular shape.

The plurality of protruding portions 157 may be configured with a first protruding portion 157a and a second protruding portion 157b.

The first protruding portion 157a may be disposed to protrude in one direction, for example, upward, from an upper surface of the extension portion 156. A front-rear width of the first protruding portion 157a may be disposed to be the same as that of the extension portion 156.

The second protruding portion 157b may be disposed to protrude in a different direction, for example, downward, from a lower surface of the extension portion 156. A front-rear width of the second protruding portion 157b may be disposed to be the same as that of the extension portion 156. The first protruding portion 157a and the second protruding portion 157b may protrude in directions opposite to each other.

The protruding portion 157 may be perpendicular to the extension portion 156.

The foregoing description of the extension portion 156 and protruding portion 157 may be applied to the first mounting portion 155a and the second mounting portion 155b, respectively. However, a left-right length of the first extension portion 156a of the first mounting portion 155a may be different from that of the second extension portion 156b of the second mounting portion 155b.

In this embodiment, it shows a state in which the left-right length of the first extension portion 156a of the first mounting portion 155a is shorter than that of the second extension portion 156b of the second mounting portion 155b.

Additionally, a left-right length of the protruding portion 157 of the first mounting portion 155a and a left-right length of the protruding portion 157 of the second mounting portion 155b may be different. In this embodiment, it shows a state in which the left-right length of the protruding portion 157 of the first mounting portion 155a is shorter than the left-right length of the protruding portion 157 of the second mounting portion 155b.

The damper 161 may be formed of an elastic material such as rubber. Through this, the damper 161 may absorb or alleviate external impact.

The damper 161 includes a receiving portion 163. The receiving portion 163 is configured to receive the mounting portion 155. The receiving portion 163 is configured to surround the mounting portion 155. The receiving portion 163 may be inserted into and coupled to the mounting portion 155.

The receiving portion 163 (see FIG. 8) may include a first receiving portion 163a and a second receiving portion 163b. The first receiving portion 163a is configured to receive the protruding portion 157. The first receiving portion 163a is configured to surround the protruding portion 157. The first receiving portion 163a may be configured to surround one side surface of the extension portion 156.

The second receiving portion 163b may extend in one direction from the first receiving portion 163a. The second receiving portion 163b is configured to receive a part of the extension portion 156. The second receiving portion 163b is configured to surround a part of the extension portion 156, for example, upper and lower surfaces of the extension portion 156.

The damper 161 may include a damper front surface portion 1611 and a damper rear surface portion 1612. The damper front surface portion 1611 constitutes a front surface of the damper 161. The damper front surface portion 1611 is configured to cover a front surface of the protruding portion 157. The damper front surface portion 1611 may also be configured to cover a front surface of a part of the extension portion 156.

The damper rear surface portion 1612 constitutes a rear surface of the damper 161. The damper rear surface portion 1612 is configured to cover a rear surface of the protruding portion 157. The damper rear surface portion 1612 may also be configured to cover a rear surface of a part of the extension portion 156.

Through this, the damper front surface portion 1611 and the damper rear surface portion 1612 may prevent the damper 161 from being separated in a front-rear direction from the mounting portion 155.

The damper 161 may further include a damper side surface portion 1613. The damper side surface portion 1613 is configured to cover a side surface of the protruding portion 157 of the damper 161. The damper side surface portion 1613 may extend to cover a side surface of the extension portion 156.

Through this, the damper side surface portion 1613 may prevent the damper 161 from being separated in a left-right direction from the mounting portion 155.

The damper 161 may further include a damper upper surface portion 1614. The damper upper surface portion 1614 is disposed to cover an upper surface of the protruding portion 157 of the damper 161. The damper upper surface portion 1614 may extend to cover a part of an upper surface of the extension portion 156.

Through this, the damper upper surface portion 1614 may prevent the damper 161 from being separated downward from the mounting portion 155.

The damper 161 may further include a damper lower surface portion 1615. The damper lower surface portion 1615 is configured to cover a lower surface of the protruding portion 157 of the damper 161. The damper lower surface portion 1615 may extend to cover a part of a lower surface of the extension portion 156.

Through this, the damper lower surface portion 1615 may prevent the damper 161 from being separated upward from the mounting portion 155.

The damper 161 may further include a curved portion 164. The curved portion 164 may be configured with a first curved portion 164a and a second curved portion 164b. The first curved portion 164a may be disposed in an arc shape with a preset curvature at an corner portion where the damper upper surface portion 1614 and the damper side surface portion 1613 are connected.

The second curved portion 164b may be disposed in an arc shape with a preset curvature at an corner portion where the damper front surface portion 1611 and the damper side surface portion 1613 are connected. The first curved portion 164a may be disposed to face and be spaced apart from a front surface portion of the inner side surface of the upper housing 101 by a preset distance.

The first curved portion 164a may be disposed to face and be spaced apart from an upper surface portion of the inner side surface of the upper housing 101 by a preset distance.

The second curved portion 164b may be disposed to face and be spaced apart from a side surface portion of the inner side surface of the upper housing 101 by a preset distance.

The curved portion 164 may be disposed to have a curvature that is the same as or similar to that of the inner side surface facing the housing 100. Through this, the curved portion 164 may minimize impact when colliding with an inner side surface of the housing 100.

The damper 161 may further include a catching protrusion 165. The catching protrusion 165 is disposed to protrude in an up-down direction from the inner side surface of the receiving portion 163 toward the extension portion 156. The catching protrusion 165 may be configured with a first catching protrusion 165a and a second catching protrusion 165b.

The first catching protrusion 165a may be disposed to protrude from an upper side of the receiving portion 163 to an upper surface of the extension portion 156. The second catching protrusion 165b may be disposed to protrude from a lower side of the receiving portion 163 to a lower surface of the extension portion 156.

The catching protrusion 165 may come into contact with one surface of the extension portion 156. As an example, the first catching protrusion 165a may protrude downward so as to come into contact with an upper surface of the extension portion 156. The second catching protrusion 165b may protrude upward to come into contact with a lower surface of the extension portion 156.

The catching protrusion 165 and the protruding portion 157 may be arranged to overlap each other in one direction, for example, in an extension direction of the extension portion 156. The catching protrusion 165 and the protruding portion 157 may be coupled to engage with each other along the one direction.

Through this, the catching protrusion 165 may prevent the damper 161 from being separated in a left-right direction from the mounting portion 155.

The damper 161 may further include a cover portion 166. The cover portion 166 may extend in a left-right direction toward an up-down center line passing through the center of the cylinder cover 150 in an up-down direction from the damper upper surface portion 1614. The upper surface (outer side surface), front surface, and rear surface of the cover portion 166 may be disposed as a flat surface.

An arc portion 167 may be disposed on a lower surface (inner side surface) of the cover portion 166. The circular portion 167 is configured to surround a round portion of the cylinder cover 150. Through this, the cover portion may cover a part of upper and side surfaces of the cylinder cover 150.

The round portion may be disposed at each corner portion of two adjacent side surfaces of the cylinder cover 150, for example, upper and side surfaces or lower and side surfaces thereof. The round portion may be disposed in an arc shape. The cover portion 166 of the damper 161 is configured to cover the round portion of the cylinder cover 150.

The damper 161 may further include an interference avoidance portion 168. The interference avoidance portion 168 is configured to avoid interference between the damper 161 and its surrounding component, for example, the cylinder block 131. The interference avoidance portion 168 may be disposed in an arc shape.

The interference avoidance portion 168 may be disposed at corner portions of the damper rear surface portion 1612 and an inner side surface portion of the damper 161. The interference avoidance portion 168 may be disposed to be concave toward an inner side of the damper 161 or the receiving portion 163 on the damper rear surface portion 1612.

The interference avoidance portion 168 may be disposed to be concave toward an inner side of the damper 161 or the receiving portion 163 on an inner side surface portion of the damper 161. The interference avoidance portion 168 may be located below the damper rear surface portion 1612 based on a horizontal center line passing through the center of a vertical length of the damper rear surface portion 1612 in a left-right direction.

Through this, the interference avoidance portion 168 may avoid interference between an corner portion of the damper rear surface portion 1612 and the inner side surface portion of the damper 161 and a part of the cylinder block 131.

The interference avoidance portion 168 may be configured to include a first interference avoidance portion 168a and a second interference avoidance portion 168b. The first interference avoidance portion 168a may be provided at an corner portion of the damper rear surface portion 1612 of the first damper 161a and the inner side surface portion of the damper 161. The second interference avoidance portion 168b may be provided at an corner portion of the damper rear surface portion 1612 of the second damper 161b and the inner side surface portion of the damper 161.

The second surface may be disposed to be spaced apart by a preset distance from an inner side surface of the housing 100. For example, an upper surface of the outer side surface of the damper 161 may be disposed to be spaced apart from that of the inner side surface of the upper housing 101 by a preset distance.

A vertical length of the damper 161 may be dispose to be greater than or equal to a distance between an upper surface of the damper 161 and an upper surface of the upper housing 101. Through this, since a press-fit coupling between the receiving portion 163 of the damper 161 and the mounting portion 155 of the cylinder cover 150 becomes loose, even when the damper 161 moves upward along the mounting portion 155, an upper surface of the damper 161 may come into contact with an upper surface of the inner side surface of the upper housing 101, thereby preventing the damper 161 from being separated upward from the mounting portion 155.

A front surface of the outer side surface of the damper 161 may be disposed to be spaced apart from that of the inner side surface of the upper housing 101 by a preset distance. A side surface of the outer side surface of the damper 161 may be disposed to be spaced apart from that of the inner side surface of the upper housing 101 by a preset distance.

Therefore, according to the present disclosure, a plurality of dampers 161 may be mounted above both side surfaces of the cylinder cover 150. The mounting portion 155 may be provided at an upper portion of a side surface of the cylinder cover 150. The mounting portion 155 may be disposed to protrude laterally from an upper portion of a side surface of the cylinder cover 150.

The mounting portion 155 may include an extension portion 156 and a protruding portion 157. The extension portion 156 is disposed to protrude laterally from a side surface of the cylinder cover 150. The protruding portion 157 may include a first protruding portion 157a and a second protruding portion 157b.

The first protruding portion 157a may be disposed to protrude upward from an upper surface of the extension portion 156. The second protruding portion 157b may be disposed to protrude downward from a lower surface of the extension portion 156.

Damper 161 includes the receiving portion 163. The receiving portion 163 is configured to receive and surround the mounting portion 155. The receiving portion 163 may be inserted into and coupled to the mounting portion 155. The receiving portion 163 may be configured with a first receiving portion 163a and a second receiving portion 163b.

The first receiving portion 163a is configured to receive and surround the protruding portion 157 and one side surface of the extension portion 156. The second receiving portion 163b is configured to receive and surround a part of the extension portion 156, for example, upper and lower surfaces thereof.

The damper 161 further includes a catching protrusion 165. The catching protrusion 165 may be configured with a first catching protrusion 165a and a second catching protrusion 165b. The first catching protrusion 165a may be disposed to protrude from the inner side surface of the receiving portion 163 toward the upper surface of the extension portion 156.

The second catching protrusion 165b may be disposed to protrude from the inner side surface of the receiving portion 163 toward the lower surface of the extension portion 156. The first catching protrusion 165a may be coupled to engage with the first protruding portion 157a. The second catching protrusion 165b may be coupled to engage with the second protruding portion 157b.

Through this, the catching protrusion 165 may limit the damper 161 from moving in a left-right direction from the mounting portion 155.

The damper 161 may further include a damper front surface portion 1611 and a damper rear surface portion 1612. The damper front surface portion 1611 constitutes a front surface of the damper 161. The damper front surface portion 1611 surrounds front surfaces of the protruding portion 157 and the extension portion 156. The damper rear surface portion 1612 constitutes a rear surface of the damper 161. The damper rear surface portion 1612 surrounds a rear surface of the damper 161.

Through this, the damper front surface portion 1611 and the damper rear surface portion 1612 may limit the damper 161 from being moved in a front-rear direction from the mounting portion 155.

The damper 161 may further include a damper upper surface portion 1614 and a damper lower surface portion 1615. The damper upper surface portion 1614 constitutes an upper surface of the damper 161. The damper lower surface portion 1615 constitutes a lower surface of the damper 161. The damper upper surface portion 1614 and the damper lower surface portion 1615 may surround upper and lower surfaces of the mounting portion 155, respectively, thereby preventing the damper 161 from being separated in an up-down direction from the mounting portion 155.

The receiving portion 163 of the damper 161 includes a straight portion. The straight portion is disposed to face a side surface of the protruding portion 157. The straight portion may be disposed as a flat surface. The side surfaces of the straight portion and the protruding portion 157 may be in surface contact with each other.

Through this, the straight portion and the protruding portion 157 of the damper 161 may be in surface contact with each other, thereby allowing the receiving portion 163 of the damper 161 and the protruding portion 157 of the mounting portion 155 to be brought into close contact with each other. A bonding force between the damper 161 and the mounting portion 155 may be maximized.

What is claimed is:

1. A compressor comprising:
a housing;
a motor unit provided on an inner side of the housing, and provided with a crankshaft, a rotor coupled to the crankshaft, and a stator surrounding the rotor;
a compression unit including a cylinder block provided on the inner side of the housing, a piston disposed to be reciprocally movable inside the cylinder block, and a connecting rod connected to the crankshaft and the piston;
a cylinder cover coupled to one side of the cylinder block; and
a damper mounted on a side surface of the cylinder cover.

2. The compressor of claim 1, wherein the damper is provided in plurality,
wherein the plurality of dampers comprises:
a first damper coupled to one side surface of the cylinder cover; and
a second damper coupled to the other side surface of the cylinder cover toward a direction opposite to the first damper.

3. The compressor of claim 1, wherein the damper is mounted on a mounting portion protruding from a side surface of the cylinder cover, and
wherein the damper comprises a receiving portion that surrounds and receives the mounting portion.

4. The compressor of claim 3, wherein the mounting portion comprises:
an extension portion extending in one direction from a side surface of the cylinder cover; and
a protruding portion disposed to protrude in a different direction crossing the one direction from the extension portion.

5. The compressor of claim 4, wherein the receiving portion comprises:
a first receiving portion configured to receive the protruding portion, and disposed in a straight shape; and
a second receiving portion configured to receive the extension portion, and extends in the one direction from the first receiving portion.

6. The compressor of claim 4, wherein the damper is provided with a curved portion on an outer corner portion of the receiving portion that receives the protruding portion, and
wherein the curved portion is spaced apart from an inner side surface of the housing by a preset distance, and disposed to correspond to a curved shape of the inner side surface of the housing.

7. The compressor of claim 6, wherein the damper comprises:
a damper upper surface portion constituting an upper surface of the damper so as to cover upper portions of the protruding portion and the extension portion;
a damper front surface portion disposed toward a direction opposite to the piston to constitute a front surface of the damper;
a damper rear surface portion disposed toward the piston to constitute a rear surface of the damper; and
a damper side surface portion connecting the damper front surface portion and the damper rear surface portion, and
wherein the curved portion comprises:
a first curved portion disposed at an corner where the damper upper surface portion and the damper side surface portion are connected; and
a second curved portion disposed at an corner where the damper front surface portion and the damper side surface portion are connected.

8. The compressor of claim 4, wherein the protruding portion is provided in plurality, and
wherein the plurality of protruding portions comprise:
a first protruding portion protruding from one side of the extension portion in another direction crossing the one direction; and
a second protruding portion protruding in still another direction crossing the one direction from one side of the extension portion toward a direction opposite to the first protruding portion.

9. The compressor of claim 8, wherein the receiving portion comprises:
a plurality of catching protrusions disposed to protrude toward one side of the extension portion, and coupled to engage with the protruding portions, and
wherein the plurality of catching protrusions comprise:
a first catching protrusion disposed to overlap the first protruding portion in the one direction; and
a second catching protrusion disposed to overlap the second protruding portion in the one direction.

10. The compressor of claim 4, wherein the damper comprises:
a damper rear surface portion disposed toward the piston to surround rear surfaces of the protruding portion and the extension portion; and
a damper front surface portion disposed toward a direction opposite to the piston to surround front surfaces of the protruding portion and the extension portion.

11. The compressor of claim 4, wherein the extension portion and the protruding portion are perpendicular to each other.

12. The compressor of claim 1, wherein the damper is arranged to be spaced apart from an inner side surface of the housing by a preset distance in at least one of up-down, front-rear, and left-right directions.

13. The compressor of claim 1, wherein the damper is a front damper disposed on a front side of the cylinder block in a direction close to the piston that moves such that refrigerant sucked into a compression chamber of the cylinder block is compressed.

14. The compressor of claim 1, wherein the cylinder cover is disposed in a square shape, and corners of the cylinder cover are fastened to the cylinder block by a plurality of fastening members, and
wherein the damper is mounted so as to cover an upper corner of the cylinder cover.

15. The compressor of claim 1, wherein the damper is a rubber material.
